(19) United States
(12) Patent Application Publication
(10) Pub. No.: US 2024/0020736 A1
(43) Pub. Date: Jan. 18, 2024

(54) EVALUATION PROCESSING METHOD AND INFORMATION PROCESSING APPARATUS

(71) Applicant: Panasonic Intellectual Property Management Co., Ltd., Osaka (JP)

(72) Inventors: Chinatsu YONEYAMA, KANAGAWA KEN (JP); Masashi FUMOTO, KANAGAWA KEN (JP); Kiyotaka TANIMOTO, KANAGAWA KEN (JP); Takenori MATSUMOTO, TOKYO TO (JP); Tatsuyuki NEGISHI, TOKYO TO (JP); Matthew KAMIYA, TOKYO TO (JP)

(73) Assignee: Panasonic Intellectual Property Management Co., Ltd., Osaka (JP)

(21) Appl. No.: 18/373,124

(22) Filed: Sep. 26, 2023

Related U.S. Application Data
(63) Continuation of application No. PCT/JP2022/001187, filed on Jan. 14, 2022.

(30) Foreign Application Priority Data
Mar. 30, 2021 (JP) 2021-056756

(51) Int. Cl. G06Q 30/0282; G06Q 30/0645; G06Q 10/02

(52) U.S. Cl. CPC G06Q 30/0282; G06Q 30/0645; G06Q 10/02

(57) ABSTRACT

An evaluation processing method according to an embodiment is a method for generating evaluation information in an information processing system that lends a cabin of a mobile body. The method includes: registering a reservation of the cabin of the mobile body from user terminals; registering, after users use the cabin of the mobile body, an evaluation for the cabin from each of the user terminals in registration information by the corresponding user; and acquiring, from the registration information, an evaluation result of the cabin evaluated by each of the users having used the cabin, specifying, among the users, a first user immediately before a second user having performed an evaluation with an evaluation result different from others in chronological order, and generating evaluation information by registering an evaluation for the first user by a lender of the cabin in the registration information as the evaluation performed by the second user.

### CROSS-REFERENCE TO RELATED APPLICATIONS

This application is a continuation of International Application No. PCT/JP2022/001187, filed on Jan. 14, 2022 which claims the benefit of priority of the prior Japanese Patent Application No. 2021-056756, filed on Mar. 30, 2021, the entire contents of which are incorporated herein by reference.

### FIELD

Embodiments described herein relate generally to an evaluation processing method and an information processing apparatus.

### BACKGROUND

A car sharing system in which one or more vehicles are communally used by a plurality of users is known. A user who uses the car sharing system can use a vehicle owned by another person such as a business operator by registering for use in advance without possessing the vehicle by himself/herself. Conventional technologies are described in JP 2020-98586 A.

In recent years, among owners of vehicles, not only owners who lend a vehicle for a means of transportation but also owners who lend the cabin of a vehicle parked in a parking lot or the like according to the purpose of users are increasing. When selecting and reserving a cabin from search results for cabins, the user refers to an evaluation result of each cabin and reserves a cabin with better conditions.

An object of the present disclosure is to provide an evaluation processing method and an information processing apparatus, which are capable of improving reliability of an evaluation with respect to a cabin of a mobile body.

### SUMMARY

An evaluation processing method according to an embodiment of the present disclosure is a method for generating evaluation information in an information processing system that lends a cabin of a mobile body. The method includes: (a) registering a reservation of the cabin of the mobile body from a plurality of user terminals for a plurality of users; (b) registering, after users of the plurality of users use the cabin of the mobile body, an evaluation for the cabin from each of user terminals for the users in registration information by the corresponding user; and (c) acquiring, from the registration information, an evaluation result of the cabin evaluated by each of the users having used the cabin, specifying, among the users, a first user immediately before a second user who has performed an evaluation with an evaluation result different from others in chronological order, and generating evaluation information by registering an evaluation for the first user by a lender of the cabin in the registration information as the evaluation performed by the second user.

### BRIEF DESCRIPTION OF THE DRAWINGS

FIG. 1A is a schematic diagram illustrating an example of an information processing system of the present embodiment;

FIG. 1B is a view illustrating an example of a cabin of the vehicle according to the present embodiment;

FIG. 2A is a diagram illustrating an example of a hardware configuration diagram of the information processing apparatus according to the present embodiment;

FIG. 2B is a diagram illustrating an example of a hardware configuration of the lender terminal of the present embodiment;

FIG. 3 is a block diagram illustrating an example of functional configurations of a lender terminal and a user terminal of the present embodiment;

FIG. 4 is a block diagram illustrating an example of a functional configuration of an information processing apparatus according to the present embodiment;

FIG. 5A is a diagram illustrating an example of a data configuration of cabin management information according to the present embodiment;

FIG. 5B is a diagram illustrating an example of a data configuration of lending management information according to the present embodiment;

FIG. 6A is an explanatory diagram illustrating a case where evaluation of a cabin of the present embodiment is not appropriately performed;

FIG. 6B is a diagram illustrating an example of a sequence of an evaluation process of the present embodiment;

FIG. 6C is a schematic diagram illustrating an example of list information according to the present embodiment;

FIG. 7A is a schematic diagram illustrating an example of a screen of lendable information output to an output unit of the user terminal of the present embodiment;

FIG. 7B is a schematic diagram illustrating an example of a screen of the lendable information output to the output unit of the user terminal of the present embodiment;

FIG. 8 is a schematic diagram illustrating an example of an input screen for receiving input of a parking lot, displayed on the lender terminal of the present embodiment;

FIG. 9 is a sequence diagram illustrating an example of a flow of registration processing executed in the information processing system of the present embodiment;

FIG. 10 is a sequence diagram illustrating an example of a flow of a use start process (step S4) executed in the information processing system of the present embodiment;

FIG. 11 is a sequence diagram illustrating an example of a flow of a use history information update process (step S6) and a lending end process (step S7) executed by the information processing system of the present embodiment;

FIG. 12 is a diagram illustrating an example of an evaluation reception screen according to the second embodiment;

FIG. 13 is a diagram for describing a method of reflecting an evaluation of a first stopping place in an evaluation of a second stopping place according to the second embodiment; and

FIG. 14 is a sequence diagram illustrating an example of a process of generating the evaluation of the second stopping place according to the second embodiment.

### DETAILED DESCRIPTION

Hereinafter, embodiments of the present disclosure will be described in detail with reference to the accompanying drawings. Note that, in each of the following embodiments, the same reference numerals are given to the same parts, and redundant description will be omitted.

### First Embodiment

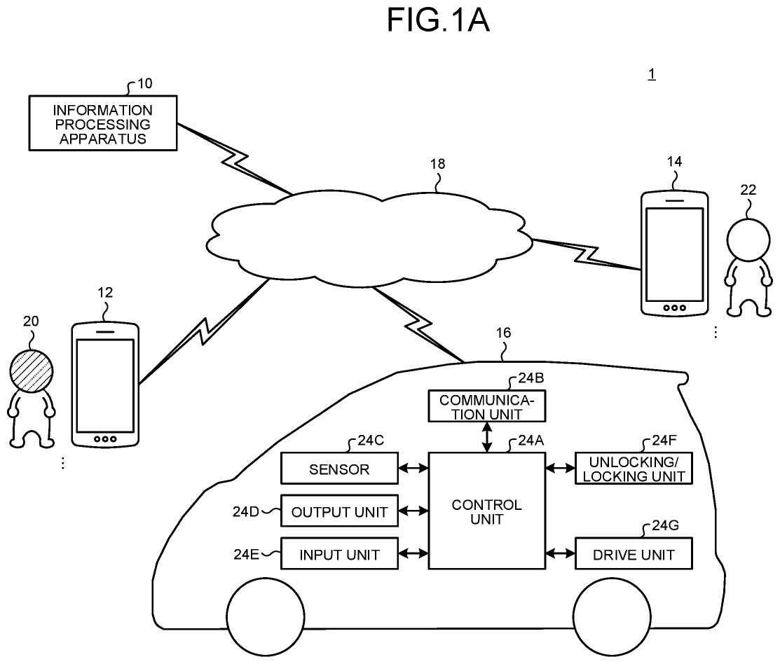

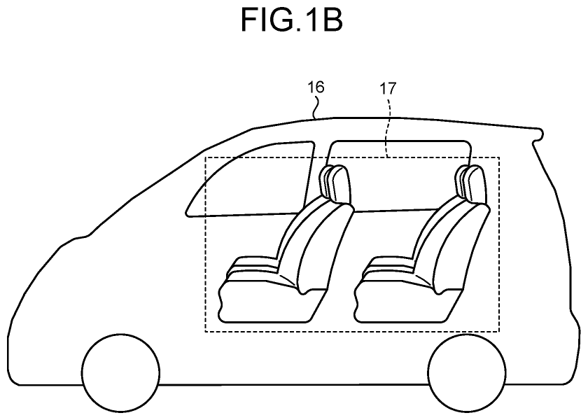

FIG. 1A is a schematic diagram illustrating an example of an information processing system 1 of the present embodiment. The information processing system 1 is a sharing system in which a cabin of a mobile body is a lending subject. FIG. 1B illustrates a cabin of a vehicle that is an example of a mobile body.

The information processing system 1 includes an information processing apparatus 10, a lender terminal 12, a user terminal 14, and a vehicle 16. The information processing apparatus 10, the lender terminal 12, the user terminal 14, and the vehicle 16 are communicably connected via a network 18 in a wireless or wired manner.

Note that FIG. 1A illustrates a configuration in which the information processing system 1 includes one information processing apparatus 10, one lender terminal 12, one user terminal 14, and one vehicle 16, but is an example for description. The information processing system 1 may be configured to include one or more lender terminals 12, one or more user terminals 14, or one or more vehicles 16.

The information processing apparatus 10 is an information processing apparatus that manages the entire information processing system 1. The information processing apparatus 10 mainly manages a cabin 17 of the vehicle 16 as a lending subject. Note that the lending subject is not limited to the cabin 17. There may be a case where the vehicle 16 is lent out as a transportation means by car sharing or the like. In this case, the information processing apparatus 10 manages the vehicle 16 not only as the cabin 17 but also as a transportation means. The information processing apparatus 10 includes, for example, a server device or a cloud system, but is not limited thereto.

Here, in the present embodiment, both a lender 20 and a user 22 are users who use the sharing system. Hereinafter, since the lender 20 is the owner of the vehicle 16, the lender 20 may be described as the “owner” when distinguished from the user 22. In the present embodiment, as an example, the information processing apparatus 10 manages lending and renting of the cabin 17 between an owner who is the lender 20 of the vehicle 16 and a user who is the user 22 of the cabin 17 of the vehicle 16.

A sharing transaction between the individual owner of the vehicle 16 and the user 22 may be referred to as inter-individual transaction or C2C (consumer-to-consumer) sharing. Note that the information processing system 1 is not limited to C2C sharing, and may be a system in which an operating organization or the like has the vehicle 16 and the user 22 who is a member uses the vehicle.

The lender 20 is an owner who lends the vehicle 16 or an owner who wishes to lend the vehicle 16. The lender terminal 12 is a terminal device operated by the lender 20. The lender terminal 12 is, for example, a tablet terminal, a smartphone, or the like, but is not limited thereto.

The user 22 is a user who rents the cabin 17 of the vehicle 16 or a user who wishes to rent the cabin. The user terminal 14 is a terminal device operated by the user 22. The user terminal 14 is, for example, a tablet terminal, a smartphone, or the like, but is not limited thereto.

The vehicle 16 is an example of a mobile body. The mobile body refers to one used as a transportation means. The mobile body may be, for example, a passenger car, a bus, a railway (including a train), or the like. Further, the mobile body may be one that moves on water such as a ship. In addition, the mobile body may be owned by an individual or may be owned by a corporation. In the present embodiment, a passenger car will be described as an example of a mobile body. The passenger car is, for example, an ordinary passenger car, a large passenger car, or a small passenger car. In addition, the power source of the vehicle 16 is not limited. For example, the vehicle 16 may be any of a gasoline vehicle, an electric vehicle, a fuel cell vehicle, and the like. In addition, the vehicle 16 may be any of a vehicle that travels through a driving operation by a person, a vehicle that can automatically travel without a driving operation by a person, and a vehicle that can autonomously travel.

The cabin refers to a space in the mobile body. The equipment varies depending on the mobile body, but the space is used by the user 22 according to the purpose. The cabin 17 of the vehicle 16 illustrated in FIG. 1B as an example is a configuration of a cabin of a general passenger car, and includes a driver's seat and/or a rear seat, and the user 22 relaxes in the vacant space according to a purpose. The setting of the space in the cabin 17 can be changed by the lender 20 of the vehicle 16 according to the use purpose of the user 22. For example, the lender 20 can enrich video equipment and/or audio equipment, arrange a table, provide a space for taking a nap, change a pattern, or optionally change the setting according to a male user and a female user, an age group of the user, a nationality, or the like.

The vehicle 16 includes a control unit 24A, a communication unit 24B, a sensor 24C, an output unit 24D, an input unit 24E, an unlocking/locking unit 24F, and a drive unit 24G. The communication unit 24B, the sensor 24C, the output unit 24D, the input unit 24E, the unlocking/locking unit 24F, and the drive unit 24G are connected to the control unit 24A so as to be able to transmit and receive data or signals.

The control unit 24A is a dedicated or general-purpose computer, and controls the vehicle 16. The communication unit 24B is a communication interface (I/F) for communicating with other devices via the network 18.

The sensor 24C is a sensor that detects a position and/or a driving state of the vehicle 16. The sensor 24C is, for example, an inertial measurement unit (IMU), a speed sensor, a global positioning system (GPS), or the like.

The output unit 24D outputs various types of information. The output unit 24D is a speaker that outputs sound, a display that displays an image, or the like. The display is, for example, a known organic electro luminescence (EL) display, a liquid crystal display, a projection device, or the like.

The input unit 24E receives an input of an instruction or information from the user. The input unit 24E is, for example, at least one of an instruction input device that receives input by user's operation input or a microphone that receives voice input. The instruction input device is, for example, a button, a pointing device such as a mouse or a trackball, or a keyboard. The instruction input device may be an input function in a touch panel provided integrally with the output unit 24D that is a display.

The unlocking/locking unit 24F is a mechanism for unlocking or locking each of one or more pieces of equipment provided in the vehicle 16. When receiving key information, the unlocking/locking unit 24F brings the equipment corresponding to the key information into an unlocked state or a locked state. The unlocked state means a state in which the equipment can be used by the user or a state in which the equipment can be driven. The locked state means a state in which the equipment is unavailable to the user or a state in which the equipment is undrivable.

The equipment is a mechanism provided in the vehicle 16. Examples of the equipment include, but are not limited to, a front window on the driver's seat side, a front window on the passenger's seat side, a rear window, an air conditioner, a front door on the driver's seat side, a front door on the passenger's seat side, audio, light, an engine, a lockable box, and the like.

The drive unit 24G is a drive device mounted on the vehicle 16. The drive unit 24G is, for example, an engine, a motor, a wheel, or the like.

Next, hardware configurations of the information processing apparatus 10, the lender terminal 12, and the user terminal 14 will be described.

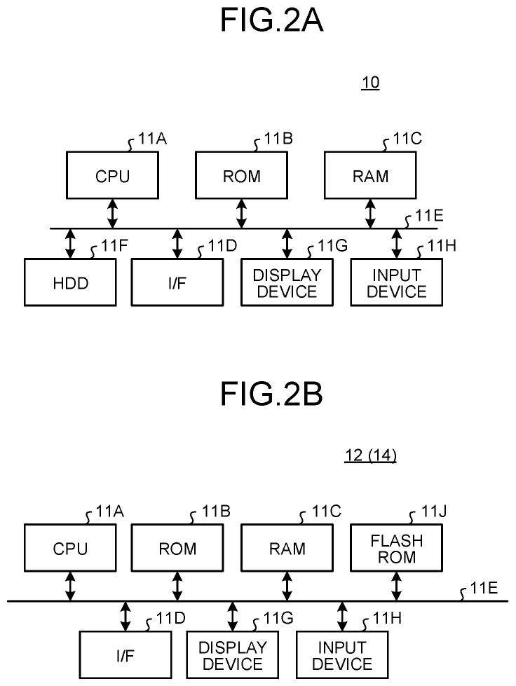

FIG. 2A is an example of a hardware configuration diagram of the information processing apparatus 10. In the information processing apparatus 10, a central processing unit (CPU) 11A, a read only memory (ROM) 11B, a random access memory (RAM) 11C, an I/F 11D, a hard disk drive (HDD) 11F, and the like are mutually connected by a bus 11E, and a hardware configuration using a normal computer is employed. Furthermore, as an example, the information processing apparatus 10 is provided with a display device 11G and an input device 11H so as to be connectable.

The CPU 11A executes a program and controls each unit to perform various processes. The ROM 11B stores fixed programs and/or data. The RAM 11C is used for a work area of the CPU 11A. The I/F 11D transmits and receives data. The I/F 11D is, for example, a network interface such as a local area network (LAN) board. The HDD 11F stores an operating system (OS), various programs, and data. Not only the HDD but also a solid state drive (SSD) or the like may be used.

FIG. 2B is a diagram illustrating an example of a hardware configuration of the lender terminal 12. Here, the hardware configuration of the user terminal 14 will be described as a hardware configuration similar to that of the lender terminal 12. The lender terminal 12 (and similarly the user terminal 14) has a hardware configuration of a computer configuration similarly to the information processing apparatus 10. Basic components of a computer similar to those of the information processing apparatus 10 are denoted by the same reference numerals, and description thereof will be omitted. Note that the display device 11G is a display such as liquid crystal or organic EL. The input device 11H will be described as a touch panel provided on a display. The flash ROM 11J stores various programs and/or data.

The user downloads a predetermined application (hereinafter abbreviated as an app) from a designated site in advance, and installs the application in the lender terminal 12 and the user terminal 14. In addition, the program executed by each of the information processing apparatus 10, the lender terminal 12, and the user terminal 14 may be provided by being incorporated in advance in the ROM 11B or the like, or the program may be acquired by download from a designated site and installed and executed in the lender terminal 12 and the user terminal 14. Further, each program may be provided by being recorded in a computer-readable recording medium such as a compact disc (CD)-ROM, a flexible disk (FD), a CD-R, and a digital versatile disk (DVD) as a file in an installable format or an executable format. The information processing apparatus 10, the lender terminal 12, and the user terminal 14 each exhibit various functions by executing a program with the CPU 11A.

Next, functional configurations of the lender terminal 12 and the user terminal 14 will be described.

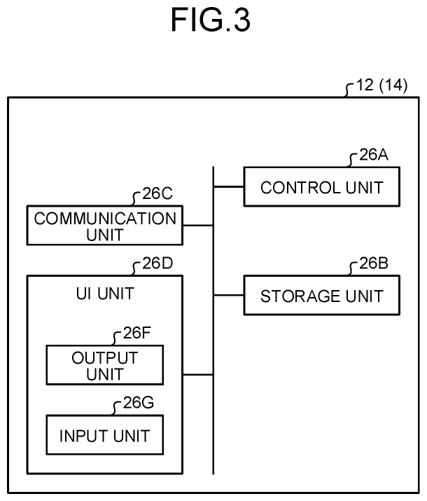

FIG. 3 is a block diagram illustrating an example of functional configurations of the lender terminal 12 and the user terminal 14. The basic functions of the lender terminal 12 and the user terminal 14 are similar.

The lender terminal 12 (and similarly the user terminal 14) includes a control unit 26A, a storage unit 26B, a communication unit 26C, and a user interface (UI) unit 26D.

The control unit 26A controls the entire lender terminal 12 (and similarly the user terminal 14). The storage unit 26B stores various data.

The communication unit 26C communicates with other devices via the network 18 by the I/F 11D. The UI unit 26D includes an output unit 26F and an input unit 26G. The output unit 26F outputs display information to the display device 11G. The input unit 26G receives an operation instruction from the user from the input device 11H.

Next, a functional configuration of the information processing apparatus 10 will be described.

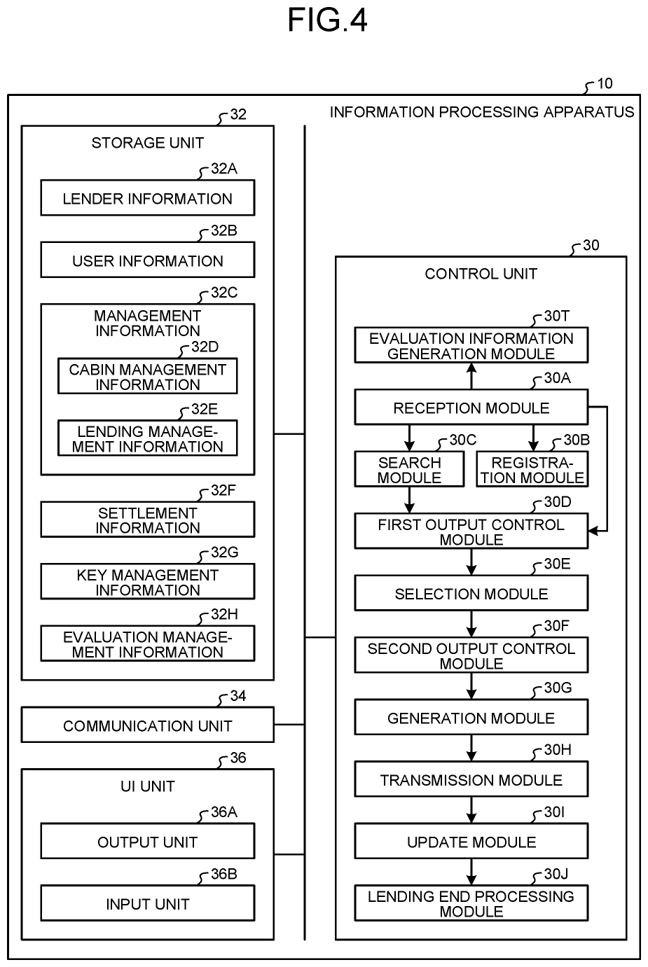

FIG. 4 is a block diagram illustrating an example of a functional configuration of the information processing apparatus 10.

The information processing apparatus 10 includes a control unit 30, a storage unit 32, a communication unit 34, and a UI unit 36. The control unit 30 performs processing by, for example, transmitting and receiving data or signals to and from the storage unit 32, the communication unit 34, and the UI unit 36.

The communication unit 34 communicates with other devices via the network 18 by the I/F 11D. The UI unit 36 includes an output unit 36A and an input unit 36B. The output unit 36A outputs the display information to the display device 11G. The input unit 36B inputs setting data and the like from the input device 11H such as a keyboard and a mouse.

The storage unit 32 stores lender information 32A, user information 32B, management information 32C, settlement information 32F, key management information 32G, and evaluation management information 32H.

Here, the lender information 32A is a management table for managing information regarding the lender 20. For example, the lender information 32A is a management table in which identification information of the lender 20, a name of the lender 20, a contact address of the lender 20, and identification information of the lender terminal 12 operated by the lender 20 are associated with each other. Note that the lender information 32A may be information further including other information regarding the lender 20. Further, the identification information of the lender 20 may be referred to as a lender identification (ID) in the description below. Further, the identification information of the lender terminal 12 may be referred to as a lender terminal ID in the description below.

The contact address of the lender 20 is, for example, an address, a mail address, a telephone number, and the like. It is assumed that the contact address of the lender 20 includes information of the contact address that can be confirmed by the lender 20 on the lender terminal 12, such as a mail address that can be received by the lender terminal 12.

The user information 32B is a management table for managing information regarding the user 22. The user information 32B is, for example, a management table in which identification information of the user 22, a name of the user 22, a contact address of the user 22, feature information of the user 22, and identification information of the user terminal 14 operated by the user 22 are associated. Note that the user information 32B may be information further including other information regarding the user 22.

The contact address of the user 22 is, for example, an address, a mail address, a telephone number, and the like. The contact address of the user 22 includes information of the contact address that can be confirmed by the user 22 on the user terminal 14, such as a mail address that can be received on the user terminal 14. The feature information of the user 22 is an inner feature or an outer feature such as a hobby, a taste, a personality, an age, or a body shape of the user 22. The identification information of the user 22 may be referred to as a user ID in the description below. The identification information of the user terminal 14 may be referred to as a user terminal ID in the description below.

The management information 32C is information for managing the cabin 17 of the vehicle 16 as a lending subject. The information processing apparatus 10 manages the cabin 17 as a lending subject by managing the management information 32C.

The management information 32C includes cabin management information 32D and lending management information 32E. The cabin management information 32D is a management table for managing the cabin 17. The lending management information 32E is a management table for managing the lending status of the cabin 17.

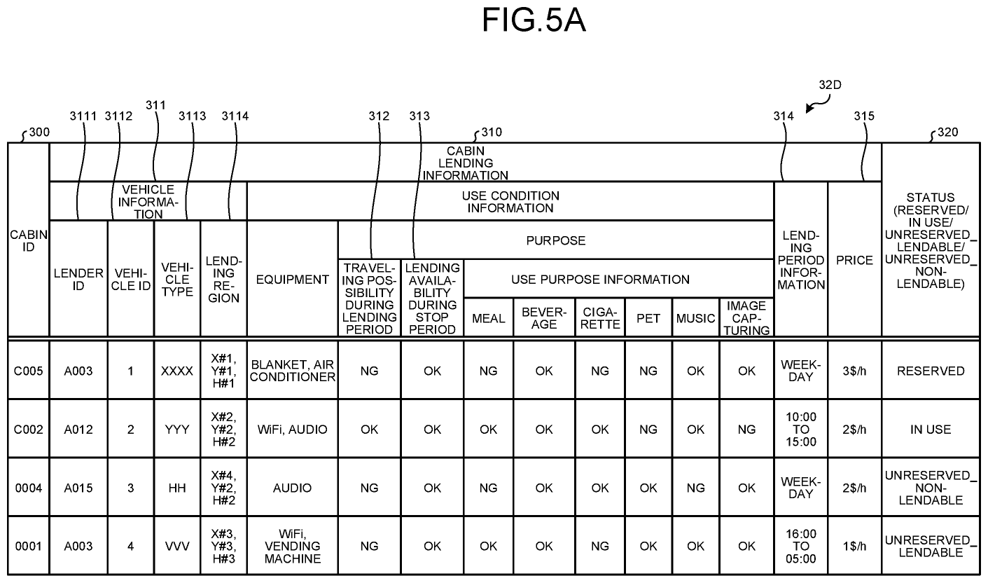

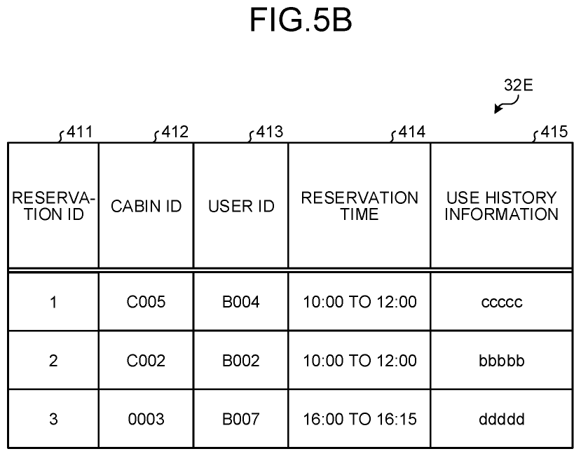

FIG. 5A is a diagram illustrating an example of a data configuration of the cabin management information 32D. The cabin management information 32D is a management table in which the cabin lending information and the status are associated with each other for each cabin 17. Specifically, the cabin management information 32D is a management table in which a cabin ID 300, cabin lending information 310, and a status 320 are associated with each other.

The cabin ID 300 is identification information of the cabin 17. The cabin lending information 310 is information regarding lending of the cabin 17 and is registered by an instruction of the lender 20. The cabin lending information 310 includes information of each of vehicle information 311, traveling possibility 312 during the lending period, lending availability 313 during the stop period, lending period information 314, and a price 315 that is a usage fee. Note that the cabin lending information 310 may be information further including other information regarding lending of the cabin 17.

The vehicle information 311 is information regarding the vehicle 16. The vehicle information 311 includes, for example, a lender ID 3111, a vehicle ID 3112, a vehicle type 3113, and a lending region 3114. The vehicle ID 3112 is identification information of the vehicle 16. The vehicle type 3113 is information indicating a vehicle type of the vehicle 16. The lending region 3114 is a region in which the vehicle 16 including the cabin 17 is scheduled to be located when the cabin 17 is lent out. Note that the vehicle information 311 may be information further including other information related to the vehicle 16.

The traveling possibility 312 during the lending period is information indicating whether or not to permit traveling of the vehicle 16 during the lending period. The traveling possibility 312 during the lending period is represented by, for example, “OK” indicating that traveling is permitted or “NG” indicating that traveling is not permitted.

The lending availability 313 during the stop period is information indicating whether or not to permit the cabin 17 of the vehicle 16 to be lent to the user 22 during the stop period of the vehicle 16.

“The cabin 17 of the vehicle 16 is permitted to be lent to the user 22 during the stop period” means that “at least a part of the stop period can be set as the lending period”. “The cabin 17 of the vehicle 16 is not permitted to be lent to the user 22 during the stop period” means “It is impossible to set all the periods of the stop period as the lending period”.

The stop period is a period in which the mobile body stops moving. The stop period is specifically a parking period or a stop period. The parking period is a period corresponding to a stop of the vehicle 16 for a predetermined time or more or a stop in a state where the driver cannot immediately drive after moving away from the vehicle 16. The stop period is a period corresponding to a stop less than a predetermined time. Further, when the mobile body is an automated driving vehicle, the stop period includes a period during which the mobile body goes around in a predetermined region.

The lending availability 313 during the stop period is represented by, for example, “OK” indicating that it is possible to lend or “NG” indicating that it is not possible to lend.

The cabin 17 of the cabin ID 300 in which the lending availability 313 during the stop period corresponds to “OK” is the cabin 17 in which at least a part of the stop period of the vehicle 16 can be set as the lending period. In the cabin 17 of the cabin ID 300 in which the lending availability 313 during the stop period corresponds to “OK”, information indicating that the vehicle 16 is lent in a stopped state is set.

Further, the cabin 17 of the cabin ID 300 in which the lending availability 313 during the stop period corresponds to “NG” is the cabin 17 in which lending during the stop period of the vehicle 16 is prohibited.

The lending period information 314 is information indicating a period in which the cabin 17 can be lent out. The lending period information 314 is represented by, for example, a lending start time and a lending end time, a weekday and a holiday, a day of the week, a date, a time slot obtained by dividing one day into a plurality of time slots, or the like. The time slot is divided into, for example, morning and afternoon, or the like.

In a case where the lending availability 313 during the stop period is “OK” indicating that lending is possible, the lending period information 314 corresponding to the lending availability 313 during the stop period indicates that the period may be at least a part of the stop period of the vehicle 16. In addition, in a case where the lending availability 313 during the stop period is “NG” indicating “no lending”, the lending period information 314 corresponding to the lending availability 313 in the stop period indicates that the period must not overlap with at least a part of the stop period of the vehicle 16.

Since the control unit 30 to be described later manages the cabin 17 as a lending subject on the basis of the cabin management information 32D, at least a part of the stop period of the vehicle 16 can be set as the lending period of the cabin 17.

In addition, it is assumed that the lending availability 313 during the stop period is “OK” indicating that it is possible to lend, and the traveling possibility 312 during the lending period is “OK” indicating that traveling is permitted. In this case, the lending period corresponding to these periods indicates that the user 22 may cause the vehicle 16 to travel during the lending period.

By the control unit 30 to be described later managing the cabin 17 as a lending subject on the basis of the cabin management information 32D, it is possible to set at least a part of the stop period of the vehicle 16 as a lending period of the cabin 17 and to set to be capable of permitting traveling during the lending period.

The price 315 is information indicating a usage fee per unit time at the time of lending or a usage fee fixed for a predetermined period. Note that the usage fee is not limited to a currency unit used in each country, and may be virtual currency or electronic money such as points. The usage fee registered in the cabin management information 32D is a usage fee in a state indicated by the corresponding vehicle information 311, the traveling possibility 312 during the lending period, the lending availability 313 during the stop period, and the lending period information 314.

The status 320 is information indicating a reservation status of the cabin 17 identified by the corresponding cabin ID 300. For example, the status 320 is information indicating reserved, in use, unreserved lendable, or unreserved non-lendable. Reserved is information indicating that the cabin 17 identified by the corresponding cabin ID 300 is reserved by the user 22. The “in use” is information indicating that the vehicle 16 identified by the corresponding cabin ID 300 is in use by the user 22. Non-reserved available for lending is information indicating that the cabin 17 identified by the corresponding cabin ID 300 is unreserved by the user 22 and available for lending. Non-reserved non-lendable for lending is information indicating that the cabin 17 identified by the corresponding cabin ID 300 is unreserved by the user 22 and unavailable for lending. The status 320 is updated under the control of the control unit 30 described later.

Next, a data configuration of the lending management information 32E will be described.

FIG. 5B is a diagram illustrating an example of a data configuration of the lending management information 32E.

The lending management information 32E is a management table for managing a usage status of the cabin 17. For example, the lending management information 32E is a management table in which a reservation ID 411, a cabin ID 412, a user ID 413, a reservation time 414, and a use history information 415 are associated with each other.

The reservation ID 411 is identification information of a lending reservation. The user ID 413 is identification information of the user 22. The reservation time 414 is information indicating a reservation time of the cabin 17. The use history information 415 is information indicating a history of an actual usage status of the cabin 17. The lending management information 32E is updated under the control of the control unit 30 described later. Therefore, it is possible to confirm whether the vehicle has been actually used by confirming the use history information, and it is possible to acquire the user ID of the user who has actually used the vehicle 16 having the same cabin ID in chronological order in order of the reservation time from the lending management information 32E.

Returning to FIG. 4, the description will be continued. The settlement information 32F is a management table in which information used for settlement is registered. For example, the settlement information 32F is a management table in which the lender ID of the lender 20 is associated with information used for settlement of the lender 20, and the user ID of the user 22 is associated with information used for settlement of the user 22. The information used for the settlement of the lender 20 is information used at the time of fee transfer or fee payment, and is, for example, bank account information or credit card information of the lender 20. The information used for the settlement of the user 22 is information used at the time of fee transfer or payment, and is, for example, bank account information or credit card information of the user 22.

The key management information 32G is a management table for managing key information for the user to unlock or lock the equipment in the cabin 17. For example, key information for unlocking each piece of equipment is registered in the key management information 32G for each piece of equipment in the cabin 17. The key information is, for example, information such as unlocking and locking a door and/or unlocking and locking the engine start.

The evaluation management information 32H corresponds to “registration information” for registering the evaluation. As an example, the evaluation management information 32H is provided as a registration table for registering an evaluation result of at least one of the vehicle 16, the cabin 17, the lender 20, and the user 22. The evaluation of the cabin 17 of the evaluation management information 32H may include evaluation for each purpose. In addition, the evaluation of the vehicle 16 or the cabin 17 of the evaluation management information 32H may include an evaluation for each place of the vehicle 16. The evaluation result registered in the evaluation management information 32H includes, for example, an evaluation result obtained by evaluating the user 22 by the lender 20 and an evaluation result obtained by evaluating the cabin 17 by the user 22. The evaluation management information 32H of the example illustrated in the present embodiment is information in which user information of the user 22 who uses the cabin 17, lender information of the lender 20 who lends the cabin 17, lending environment information, and evaluation information that is an evaluation result of the user 22 and the cabin 17 are associated with each other. The lending environment information is information indicating a lending environment, and includes information such as a date and time of lending and a place of lending.

In addition, the evaluation management information 32H may include purpose information indicating a use purpose in which the user 22 actually uses the cabin 17. The information processing apparatus 10 provides a data item of “actually used purpose” in the evaluation management information 32H, and receives and registers data of “actually used purpose” after using the cabin from the user 22.

Various pieces of information stored in the storage unit 32 are appropriately registered and updated by processing to be described later by the control unit 30. Details of these processes will be described later.

Note that the data formats of respective pieces of the information stored in the storage unit 32 are not limited to those held as various information tables such as a management table or a registration table.

Next, the control unit 30 will be described. The control unit 30 includes a reception module 30A, a registration module 30B, a search module 30C, a first output control module 30D, a selection module 30E, a second output control module 30F, a generation module 30G, a transmission module 30H, an update module 30I, and a lending end processing module 30J. Furthermore, the control unit 30 includes an evaluation information generation module 30T.

The reception module 30A, the registration module the search module 30C, the first output control module the selection module 30E, the second output control module 30F, the generation module 30G, the transmission module 30H, the update module 30I, the lending end processing module 30J, and the evaluation information generation module are implemented by, for example, one or more processors. For example, each of the above units may be implemented by causing a processor such as a CPU to execute a program, that is, by software. Each of the above units may be implemented by a processor such as a dedicated integrated circuit (IC), that is, hardware. Each of the above units may be implemented by using software and hardware in combination. When a plurality of processors is used, each of the plurality of processors may implement one of the plurality of units, or may implement two or more of the plurality of units.

The processor reads and executes a program stored in a storage unit (the HDD 11F or the like) to implement the plurality of units. Note that the information processing apparatus 10 may be configured to directly incorporate the program in the circuit of the processor instead of storing the program in the storage unit (the HDD 11F or the like). In this case, the processor implements the plurality of units by reading and executing the program incorporated in the circuit.

The reception module 30A receives various types of information from the lender terminal 12, the user terminal 14, and the vehicle 16 via the communication unit 34.

Specifically, the reception module 30A receives, from the lender terminal 12, lender information, cabin lending information, evaluation information that is an evaluation result by the lender 20, and the like. Furthermore, the reception module 30A receives, from the user terminal 14, user information, use reservation information, a use request, evaluation information that is an evaluation result by the user 22, and the like. The reception module corresponds to a “first receiving unit” that receives the reservation information of the cabin 17 from the plurality of user terminals 14, and corresponds to a “second receiving unit” that receives the registration information including the evaluation of the cabin 17 from the user terminal 14 of the user 22.

The use reservation information is information input by the user 22 who makes a use reservation of the cabin 17. In other words, the use reservation information is a search condition of the cabin 17 desired to be used by the user 22, and is information including one or more search words. The use reservation information includes, for example, at least one search word of a date, a use start time, a use time, and a use place scheduled to use the cabin 17. Note that the use reservation information may be information further including another search word. For example, the use reservation information may be information further including search words such as a vehicle type of the vehicle 16, feature information of the lender 20 who owns the vehicle 16, and evaluation information of the vehicle 16, the cabin 17, or the lender 20.

The use request is information input by the user 22 who makes a use reservation of the cabin 17. The use request is information including cabin lending information of the cabin 17 desired to be used by the user 22 among one or more pieces of cabin lending information matching at least one of the search conditions indicated in the use reservation information, and a request signal for requesting use of the cabin 17.

The registration module 30B executes registration processing such as registration of the lender information in the lender information 32A, registration of the user information in the user information 32B, registration of the cabin lending information in the cabin management information 32D, and registration in the evaluation management information 32H.

Upon receiving the lender information from the lender terminal 12, the registration module 30B registers the lender information in the lender information 32A. Further, upon receiving the user information from the user terminal 14, the registration module 30B registers the user information in the user information 32B. In addition, upon receiving the cabin lending information from the lender terminal 12, the registration module 30B registers the cabin lending information in the cabin management information 32D.

The evaluation information generation module 30T performs evaluation information generation processing such as acquiring an evaluation registered by a lending end processing module 30J to be described later from the evaluation management information 32H and correcting the evaluation. For example, in a case where the same vehicle 16 is continuously used, if the users are different from each other, there is a case where a person who has contaminated the cabin 17 on the way cannot be recognized. In such a case, since the evaluation of the cabin 17 may not be appropriately performed and the evaluation may be low, after the evaluation is registered, the evaluation information corrected to an appropriate evaluation by the evaluation information generation module 30T is generated and registered again.

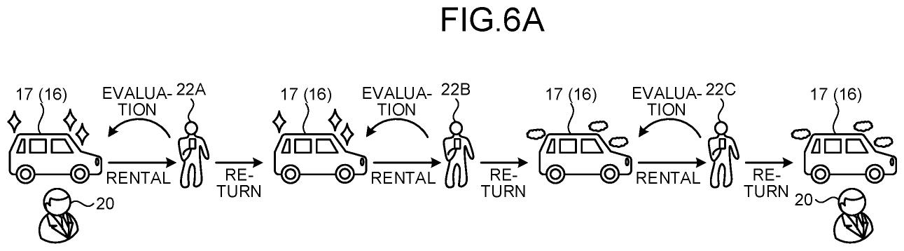

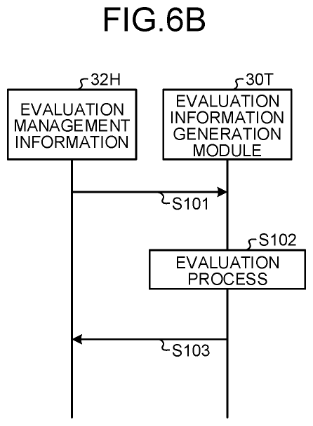

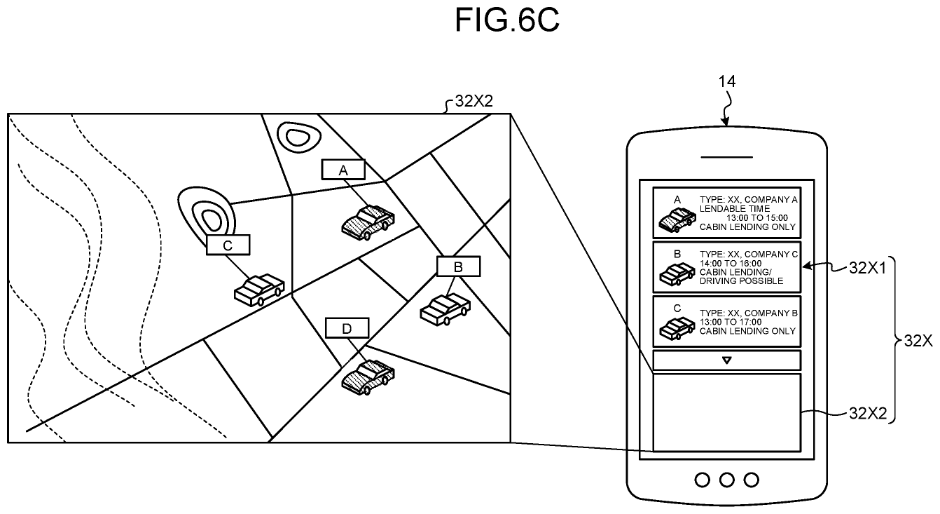

FIG. 6A is an explanatory diagram illustrating a case where evaluation of the cabin 17 is not appropriately performed. As illustrated in FIG. 6A, it is assumed that a user 22A, a user 22B, and a user 22C, which are different users 22, continuously use the same cabin 17. The owner, who is the lender 20 of the vehicle 16, inspects the cabin 17 after lending the cabin 17 and performs evaluation as the lender 20, but for example, when the user 22 uses the cabin 17 for a short time to change the user 22 one after another, it is difficult for the owner to inspect the cabin 17 every time the user changes. In that case, the inspection is performed at a certain timing.

This example is an example of a case where the owner performs an inspection after the user 22A, the user 22B, and the user 22C use the cabin 17. If the user 22B contaminates the cabin 17, the user 22B evaluates that the cabin 17 is clean, that is, gives a good evaluation because the cabin 17 is originally clean. However, since the user 22C who is the next user uses the cabin 17 contaminated by the user 22B, the user gives a bad evaluation (bad evaluation) to the cabin 17. When the owner checks the cabin 17, the cabin 17 is dirty, but it is not known which user 22 has contaminated the cabin 17. In this example, since the user 22B who is the second user among three users 22 contaminates the cabin 17, the user 22C who is the last user gives one bad evaluation of the cabin 17, but when the number of users 22 is large and the first user 22 contaminates the cabin 17, the bad evaluation of the cabin 17 is added. In this case, the evaluation of the cabin 17 becomes unreliable. In addition, not only when the user 22 evaluates the cabin 17 but also when the owner and the user 22 can mutually evaluate, the owner does not know which user 22 should be evaluated well and which user 22 should be evaluated poorly.

Accordingly, as illustrated in FIG. 6B, after the evaluation of the cabin 17 by each user 22 is registered, the evaluation information generation module 30T acquires the evaluation information on the cabin 17 of the user 22 in the same cabin 17 from the evaluation management information 32H (S101). Then, the evaluation information generation module identifies, from the evaluation information, the first user (in this example, the user 22B) immediately before the second user (in this example, the user 22C) who has given a different evaluation in chronological order, and re-registers the evaluation of the first user (the user 22B) by the lender of the cabin 17 as the evaluation performed by the second user (the user 22C) (that is, the evaluation (poor evaluation) of the cabin 17 performed by the user 22C) in the evaluation management information 32H (S102 and S103). That is, the evaluation information generation module 30T performs correction to replace the registered evaluation information with an appropriate evaluation. Therefore, the evaluation (poor evaluation) of the cabin 17 registered in the evaluation management information 32H by the second user (user 22C) is rewritten to the same evaluation (good evaluation) as the others. Note that the evaluation (poor evaluation) of the cabin 17 by the second user (user 22C) may be discarded without being rewritten to the same evaluation (poor evaluation) as the others. The series of processes described above increases the reliability of the evaluation on the cabin 17 and the user 22.

The search module 30C searches the cabin management information 32D for the cabin lending information satisfying the use reservation information received from the user terminal 14. The search module 30C searches the cabin management information 32D for the cabin lending information that matches or is similar to one or more search words included in the use reservation information received by the reception module 30A.

For example, it is assumed that the use reservation information received by the reception module 30A includes the use start time and the use time scheduled to use the cabin 17. In this case, the search module 30C searches the cabin management information 32D for the cabin lending information including the lending period in which at least a part of the period overlaps from the use start time until the use time elapses. Here, the description will be continued on the assumption that the search module 30C searches the cabin management information 32D for a plurality of pieces of cabin lending information, that is, cabin lending information corresponding to a plurality of cabin IDs.

The first output control module 30D outputs the list information to the output unit 26F of the user terminal 14. The list information may include the evaluation information of each cabin 17 registered in the evaluation management information 32H and be output to the output unit 26F of the user terminal 14. For example, when the user 22 searches the cabin 17 with the user terminal 14 and outputs information of the corresponding cabin 17 to the output unit 26F of the user terminal 14, information such as the number of evaluations and/or the number of star emoji images (⋆) is output according to the evaluation information of the cabin 17. On the side of the user terminal 14, the retrieved evaluation of the cabin 17 is displayed by the number of evaluations and/or the number of star emoji images.

The list information is information of the cabin 17 of the vehicle 16 in which at least a part of the stop period is set as the lending period. Specifically, the list information is information indicating a list of the cabin lending information of the cabin 17 of the vehicle 16 searched by the search module 30C. Note that the list information only needs to include the cabin lending information of one or more cabins 17.

The vehicle 16 is the vehicle 16 in which at least a part of the stop period can be set as the lending period. Further, the vehicle 16 may be a vehicle in which at least a part of the stop period is set as a lending period and can be set to be capable of permitting traveling during the lending period.

Thus, the first output control module 30D outputs the list information, which is a list of the cabin lending information of the cabin 17 of the vehicle 16, to the output unit 26F of the user terminal 14. In addition, the first output control module 30D can also output the list information of the cabin 17 of the vehicle 16, which is the cabin 17 of the vehicle 16 set to be capable of permitting traveling during the lending period, to the output unit 26F of the user terminal 14. The cabin 17 can also be narrowed down by the number of evaluations and/or star emoji images from each cabin 17 included in the list information.

FIG. 6C is a schematic diagram illustrating an example of list information 32X. The list information 32X includes one or more pieces of cabin lending information searched by the search module 30C. For example, the list information 32X includes character information 32X1 that is cabin lending information and an image 32X2 that is cabin lending information. Character information 32X1 may include the number of evaluations and/or star emoji images. The image 32X2 is, for example, an image in which an image indicating the corresponding cabin lending information is arranged at a position corresponding to the lending region on the map image. The image indicating the cabin lending information is represented by, for example, an image schematically illustrating the vehicle 16.

The user 22 operates the user terminal 14 while referring to the list information 32X displayed on the user terminal 14, thereby selecting one piece of cabin lending information desired to be used. Then, the user terminal 14 transmits a use request including the selected cabin lending information and a request signal for requesting use of the cabin 17 to the information processing apparatus 10.

Note that the output unit from which the first output control module 30D outputs the list information 32X only needs to be any output mechanism that can be browsed by the user 22, and is not limited to the output unit 26F provided in the user terminal 14. For example, the first output control module 30D may use various displays connected to the network 18 as an output unit that outputs the list information 32X. The display is, for example, a bulletin board or an electronic signboard, but is not limited thereto. The first output control module 30D may be used as an output unit that outputs the list information 32X to a speaker that is connected to the network 18 and outputs a voice.

Returning to FIG. 4, the description will be continued. The selection module 30E selects the cabin lending information included in the use request received from the user terminal 14 as the cabin lending information of the cabin 17 that is the subject of lending to the user 22. That is, the selection module 30E selects the cabin lending information of the cabin 17 that is the subject of lending to the user 22 from the cabin lending information of the cabin 17 included in the list information 32X on the basis of an instruction of the user 22.

The second output control module 30F outputs lendable information to the output unit 26F of the user terminal 14.

The lendable information is information indicating that the cabin 17 selected by the selection module 30E is available for lending. The lendable information includes, for example, at least part of information included in the cabin lending information of the cabin 17 selected by the selection module 30E, and information indicating that the cabin 17 is to be lent out.

Note that the second output control module 30F calculates, as the actual reservation time, an overlap period between the period from the use start time included in the use reservation information received from the user terminal 14 until the use time elapses and the lending period included in the lendable information. Then, the second output control module 30F outputs the cabin lending information including the reservation time instead of the lending period to the user terminal 14 as the lendable information.

In addition, the second output control module 30F registers the user ID of the user 22 of the user terminal 14, which is the output destination of the lendable information, the cabin ID included in the lendable information, the calculated reservation time, and the reservation ID in the lending management information 32E in association with each other (see FIG. 5B).

The user terminal 14 that has received the lendable information displays the lendable information on the output unit 26F of the user terminal 14. Thus, the user 22 can confirm the cabin lending information of the cabin 17 permitted to be used by the user 22 by referring to the user terminal 14.

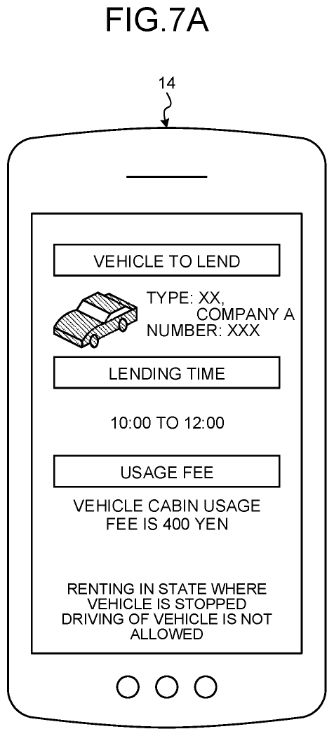

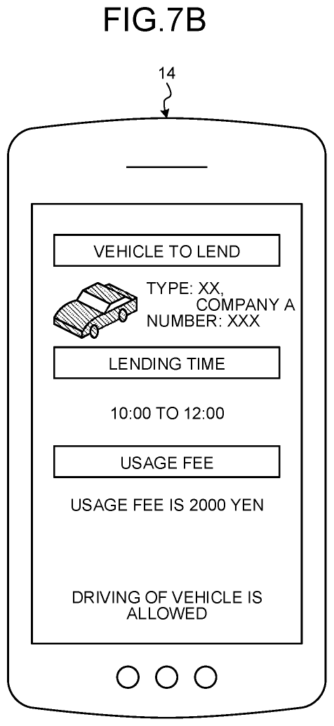

FIGS. 7A and 7B are schematic diagrams illustrating an example of a screen of the lendable information output to the output unit 26F of the user terminal 14.

For example, it is assumed that the cabin lending information included in the lendable information includes “NG” as information indicating traveling possibility during the lending period, and includes “OK” as information indicating lending availability during the stop period. In this case, for example, the lendable information illustrated in FIG. 7A is output to the output unit 26F of the user terminal 14.

In addition, for example, it is assumed that the cabin lending information included in the lendable information includes “OK” as the information indicating traveling possibility during the lending period, and includes “OK” as the information indicating lending availability during the stop period. In this case, for example, the lendable information illustrated in FIG. 7B is output to the output unit 26F of the user terminal 14.

As illustrated in FIGS. 7A and 7B, the usage fee may be different between a case where the vehicle 16 is lent in a stopped state (see FIG. 7A) and a case where the vehicle 16 is lent in a state where traveling is permitted (see FIG. 7B).

Returning to FIG. 4, the description will be continued. Note that, as described above, the lending region included in the cabin lending information registered in the cabin management information 32D is a region in which the vehicle 16 including the cabin 17 is scheduled to be located when the cabin 17 is lent out. Thus, in a case where the subject of lending to the user 22 is selected by the selection module 30E, the information processing apparatus 10 preferably notifies the user 22 of information indicating the actual lending position of the vehicle 16.

Accordingly, the second output control module 30F preferably transmits selection information to the lender terminal 12 before outputting the lendable information to the output unit 26F of the user terminal 14. The selection information is information including at least an input instruction signal of parking lot information. For example, the selection information includes the cabin lending information of the cabin 17 selected by the selection module 30E and the input instruction signal of the parking lot information.

The parking lot is a region having a size of one vehicle 16. The parking lot information is information indicating a parking lot in the lending region of the vehicle 16 having the cabin 17 selected by the selection module 30E.

When the lender terminal 12 receives the selection information, the lender 20 of the lender terminal 12 inputs the parking lot information in which the vehicle 16 owned by the lender 20 is actually arranged. In this case, for example, the lender terminal 12 displays an input screen for receiving input of a parking lot on the lender terminal 12.

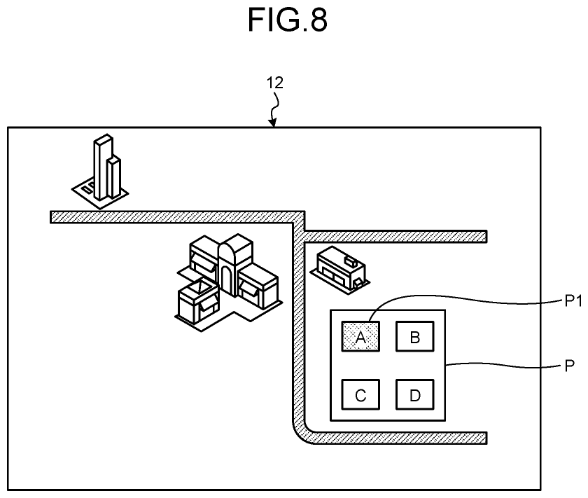

FIG. 8 is a schematic diagram illustrating an example of an input screen for receiving input of a parking lot displayed on the lender terminal 12. For example, the lender 20 inputs an instruction for the parking lot P1 in which the vehicle 16 is actually parked in the lending region P through the lender terminal 12. Then, the lender terminal 12 transmits the parking lot information of the parking lot P1 for which the instruction has been input to the information processing apparatus 10.

Returning to FIG. 4, the description will be continued. The second output control module 30F of the information processing apparatus 10 receives the parking lot information from the lender terminal 12 via the reception module 30A and the communication unit 34. Then, the second output control module 30F outputs the lendable information further including the parking lot information received from the lender terminal 12 to the user terminal 14.

Next, the generation module 30G will be described. The generation module 30G generates key information. The generation module 30G generates key information for making the cabin 17 used by the user 22 usable. The transmission module 30H transmits the key information generated by the generation module 30G to the user terminal 14 to which the generation module 30G has output the lendable information immediately before. The user terminal 14 that has received the key information stores the received key information.

The update module 30I updates the lending management information 32E. The update module 30I detects an actual usage status of the cabin 17 during the use period by the user 22, and registers the usage status as the use history information in the lending management information 32E. The actual usage status of the cabin 17 includes, for example, position information of the vehicle 16 detected by the sensor 24C of the vehicle 16, operating states of various electronic devices mounted on the vehicle 16, and the like.

The control unit 24A of the vehicle 16 detects the usage status of the cabin 17 by analyzing the signals output from the sensor 24C, the input unit 24E, and the drive unit 24G by a known method, and transmits the detection result to the information processing apparatus 10. The update module 30I of information processing apparatus 10 receives the detection result from the vehicle 16 via the reception module and the network 18. Then, the update module 30I registers the received detection result in the lending management information 32E as the use history information.

The lending end processing module 30J executes a lending end process. The lending end process is processing executed at the end of use of the cabin 17 by the user 22. The lending end process includes, for example, an end time notification process, a key information invalidation process, a fee calculation process, a settlement process, an evaluation process, and the like.

For example, the lending end processing module 30J notifies at least one of the user terminal 14 or the vehicle 16 of the end time of the reservation time as the end time notification process. Specifically, the lending end processing module 30J refers to the lending management information 32E, and when the time is a predetermined time before the end time of the reservation time registered in the lending management information 32E, the lending end processing module 30J notifies the user terminal 14 of the user 22 identified by the user ID corresponding to the reservation time of the end time of the reservation time. Note that the lending end processing module 30J may notify the vehicle 16 identified by the cabin ID corresponding to the reservation time of the end time of the reservation time.

At least one of the user terminal 14 or the vehicle 16 that has received the end time of the reservation time outputs information indicating the end time. Thus, the end time of the reservation time is provided to the user 22 who is using the cabin 17 of the vehicle 16.

Further, for example, the lending end processing module 30J invalidates the key information transmitted to the user terminal 14 to a state in which switching to the unlocked state of the equipment of the vehicle 16 is impossible as the key information invalidation process.

Furthermore, for example, the lending end processing module 30J calculates the fee from the time from the start of use to the end of use and the usage fee registered in the cabin management information 32D as the fee calculation process. Then, the lending end processing module 30J transmits fee information of the calculated fee to the user terminal 14 and the lender terminal 12. Then, the lending end processing module 30J executes the settlement process such as direct debit of the calculated fee of the fee information from a bank account of the user 22 and transfer to the bank account of the lender 20.

Furthermore, for example, the lending end processing module 30J receives the evaluation information from each of the lender terminal 12 and the user terminal 14 and registers the evaluation information in the evaluation management information 32H as the evaluation process. At this time, the lending end processing module 30J registers the user information of the user 22 who has used the cabin 17, the lender information of the lender 20 who has lent the cabin 17, the lending environment information, and the received evaluation information of at least one of the lender 20, the user 22, the vehicle 16, or the cabin 17 in the evaluation management information 32H in association with each other. Thus, information of lending and renting between the lender 20 and the user 22 is registered and managed in the evaluation management information 32H together with each piece of evaluation information.

Next, an example of a flow of information processing executed by the information processing system 1 will be described. First, a flow of registration processing by the registration module 30B will be described.

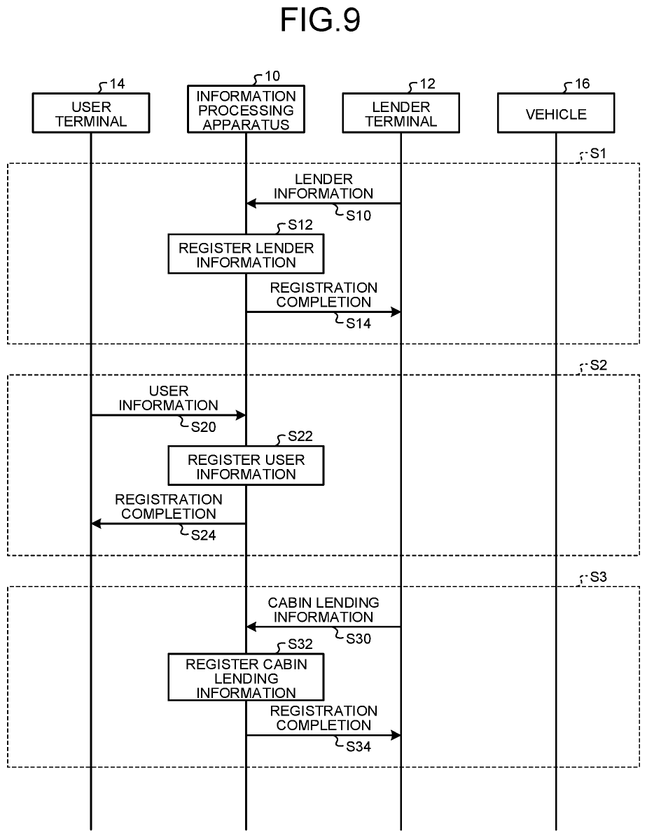

FIG. 9 is a sequence diagram illustrating an example of a flow of registration processing executed in the information processing system 1.

First, the registration processing of the lender information (step S1) will be described. The lender 20 operates the lender terminal 12 to input the lender information including the name of the lender 20, the contact address of the lender 20, and the like. The lender terminal 12 transmits the input lender information to the information processing apparatus 10 via the network 18 (step S10). The registration module 30B of the information processing apparatus 10 registers the lender information received from the lender terminal 12 in association with the lender ID of the lender 20 in the lender information 32A (step S12). Then, the registration module 30B of the information processing apparatus 10 transmits information indicating registration completion to the lender terminal 12 (step S14).

The lender information is input by each of one or more lenders 20 operating each of the lender terminals 12. Then, every time the lender information is input to the lender terminal 12, the information processing system 1 executes the registration processing of the lender information (step S1).

Next, registration processing of the user information (step S2) will be described. The user 22 operates the user terminal 14 to input the user information including the name of the user 22, the contact address of the user 22, the feature information of the user 22, and the like. The user terminal 14 transmits the input user information to the information processing apparatus 10 via the network 18 (step S20). The registration module 30B of the information processing apparatus 10 registers the user information received from the user terminal 14 in the user information 32B in association with the user ID of the user 22 (step S22). Then, the registration module 30B of the information processing apparatus 10 transmits information indicating registration completion to the user terminal 14 (step S24).

The user information is input by each of one or more users 22 operating each user terminal 14. Then, every time the user information is input to the user terminal 14, the information processing system 1 executes user information registration processing (step S2).

Next, the registration processing of the cabin lending information (step S3) will be described. The lender 20 inputs the cabin lending information by operating the lender terminal 12. Specifically, the lender 20 operates the lender terminal 12 to input each information of the vehicle information, traveling possibility during the lending period, lending availability during the stop period, the lending period, and the usage fee.

The lender terminal 12 transmits the input cabin lending information to the information processing apparatus via the network 18 (step S30). The registration module of the information processing apparatus 10 registers the cabin lending information received from the lender terminal 12 in the cabin management information 32D in association with the cabin ID of the cabin 17 (step S32). Then, the registration module 30B of the information processing apparatus 10 transmits information indicating registration completion to the lender terminal 12 (step S34).

The cabin lending information is input by each of one or more lenders 20 operating each lender terminal 12. Then, every time the cabin lending information is input to the lender terminal 12, the information processing system 1 executes registration processing of the cabin lending information (step S3).

Next, the flow of the use start process from the input of the use reservation information from the user terminal 14 to the start of use of the cabin 17 will be described.

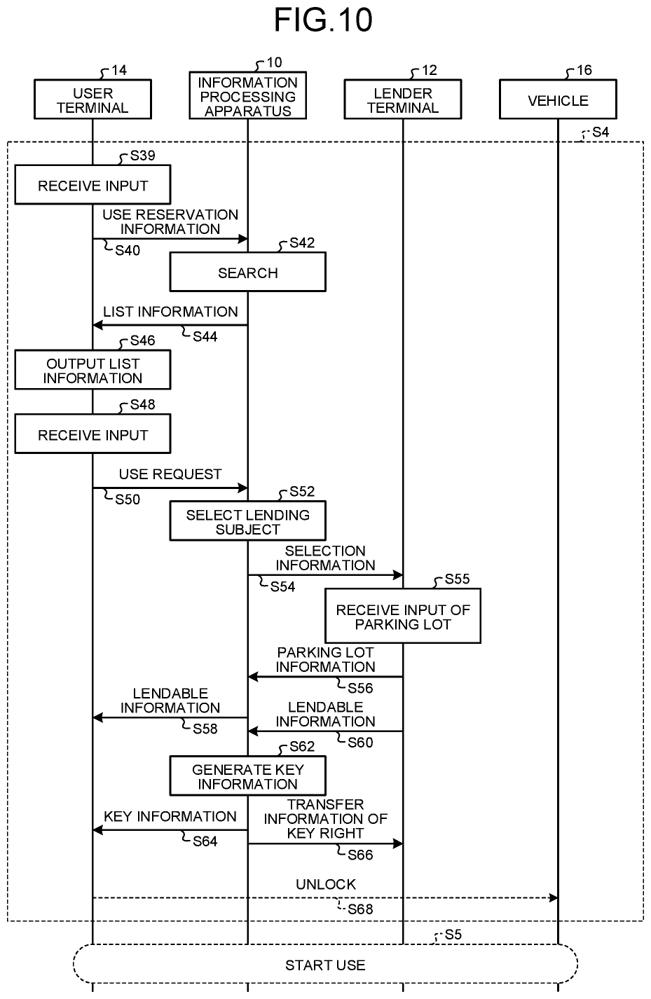

FIG. 10 is a sequence diagram illustrating an example of a flow of the use start process (step S4) executed by the information processing system 1.

By operating the user terminal 14, the user 22 inputs the use reservation information that is a search condition of the cabin 17 desired to be used by the user 22 and is information including one or more search words. As described above, the search words are the use start time, the use time, the use place, and the like scheduled to use the cabin 17. The user terminal 14 receives input of the use reservation information by the user 22 (step S39). The user terminal 14 transmits the received use reservation information to the information processing apparatus 10 (step S40). The search module 30C of the information processing apparatus 10 searches the cabin management information 32D for the cabin lending information satisfying the use reservation information received from the user terminal 14 (step S42).

The first output control module 30D transmits the list information 32X, which is a list of the cabin lending information searched by the search module 30C, to the user terminal 14 (step S44). The user terminal 14 outputs the list information 32X to the output unit 26F of the user terminal 14 (step S46) (see FIG. 6C).

The user 22 operates the user terminal 14 while referring to the list information 32X (including the evaluation number and/or star emoji image) displayed on the user terminal 14, thereby selecting one piece of cabin lending information desired to be used. The user terminal 14 receives input of the selected cabin lending information (step S48). The user terminal 14 transmits a use request including the received cabin lending information and a request signal for requesting use of the cabin 17 to the information processing apparatus 10 (step S50).

The selection module 30E of the information processing apparatus 10 selects the cabin lending information included in the use request received in step S50 as the cabin lending information of the cabin 17 that is the lending subject (step S52).

The selection module 30E of the information processing apparatus 10 transmits selection information including the cabin lending information of the cabin 17 selected in step S52 and the input instruction signal of the parking lot information to the lender terminal 12 of the lender 20 identified by the lender ID included in the cabin lending information (step S54).

When the lender terminal 12 receives the selection information, the lender 20 of the lender terminal 12 inputs the parking lot information in which the vehicle 16 owned by the lender 20 is actually arranged. For example, the lender terminal 12 displays an input screen for receiving input of the parking lot on the lender terminal 12 (see FIG. 8). Upon receiving input of a parking lot (step S55), the lender terminal 12 transmits the parking lot information of the received parking lot to the information processing apparatus 10 (step S56).

The second output control module 30F of the information processing apparatus 10 transmits, to the user terminal 14, the lendable information including the parking lot information received in step S56 and indicating that the cabin 17 selected by the selection module 30E in step S52 is available for lending (step S58). The user terminal 14 outputs the lendable information to the output unit 26F of the user terminal 14 (see FIGS. 7A and 7B).

Next, the generation module 30G of the information processing apparatus 10 generates key information (step S62). Then, the transmission module 30H of the information processing apparatus 10 transmits the key information generated in step S62 to the user terminal 14 that has transmitted the lendable information in step S58 (step S64). The user terminal 14 that has received the key information stores the received key information. In addition, the transmission module 30H of the information processing apparatus 10 transmits, to the lender terminal 12, transfer information indicating that key right has been transferred to the user 22 (step S66).

When the key information is communicated between the user terminal 14 and the vehicle 16, the equipment in the cabin 17 of the vehicle 16 is unlocked (step S68). Thus, the cabin 17 specified by the lendable information received from the information processing apparatus 10 in step S58 becomes available to the user 22.

For example, when the user 22 brings the user terminal 14 close to the vehicle 16 in the cabin 17 permitted to be used, communication between the user terminal 14 and the vehicle 16 is executed by a known technology, and equipment such as a door of the cabin 17 of the vehicle 16 is unlocked. Thus, the user 22 can start using the cabin 17 and can start using the cabin 17.

Specifically, for example, when the user 22 brings the user terminal 14 close to the cabin 17, the key information of the user terminal 14 is transmitted to the vehicle 16 by near field communication between the user terminal 14 and the vehicle 16. The control unit 24A of the vehicle 16 authenticates whether or not the received key information is valid key information by a known method, and when the received key information is valid key information, the equipment corresponding to the key information is unlocked. For example, the control unit 24A switches the unlocking/locking unit 24F corresponding to a door, which is an example of equipment corresponding to the key information, to the unlocked state. This process allows the user 22 to enter the cabin 17. Then, the use start process (step S4) ends. Thus, the use of the cabin 17 by the user 22 is started (step S5).

Next, a flow of an update process of the use history information and the lending end process will be described.

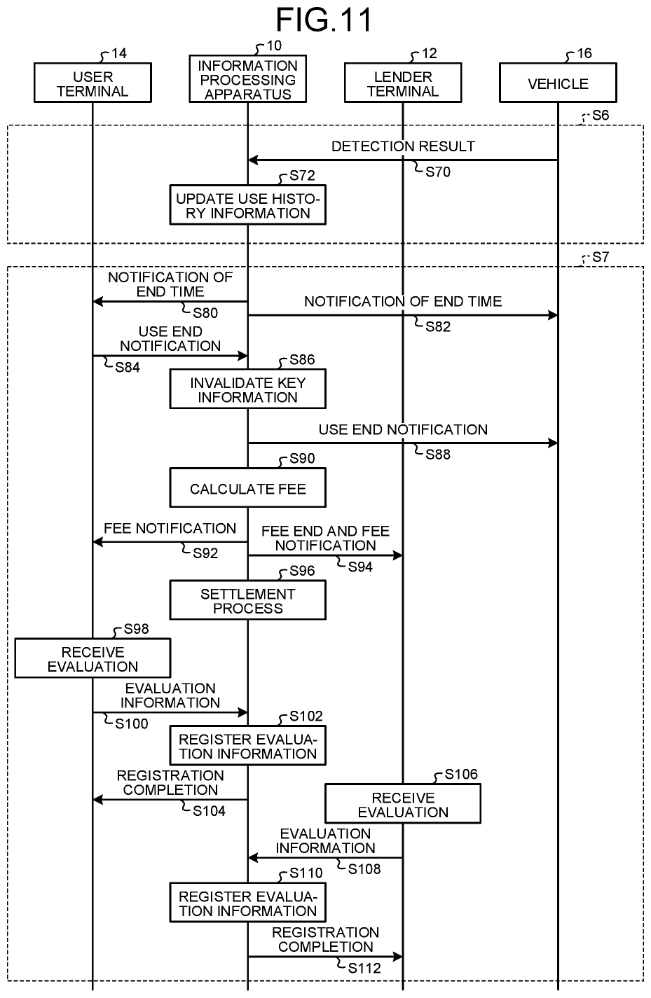

FIG. 11 is a sequence diagram illustrating an example of flows of the update process of the use history information (step S6) and the lending end process (step S7) executed by the information processing system 1.

The process of updating the use history information (step S6) includes processing of steps S70 to S72.

First, when the use of the cabin 17 by the user 22 is started, the control unit 24A of the vehicle 16 acquires the detection result of the usage status including the position information of the vehicle 16 detected by the sensor 24C of the vehicle 16, the operating state of each of the various electronic devices mounted on the vehicle 16, and the like. The control unit 24A of the vehicle 16 only needs to acquire the detection result every predetermined time or every time the situation changes. Then, the control unit 24A of the vehicle 16 transmits the detection result of the usage status of the cabin 17 to the information processing apparatus 10 (step S70).

The update module 30I of the information processing apparatus 10 registers the detection result received in step S70 in the lending management information 32E (see FIG. 5B) as the use history information (step S72). The update module 30I only needs to register the detection result in the lending management information 32E as the use history information every time the detection result is received from the vehicle 16. Thus, the lending management information 32E is updated during the use period.

Next, the lending end process (step S7) will be described. The lending end process (step S7) includes processing of steps S80 to S112.

The lending end processing module 30J of the information processing apparatus 10 notifies the user terminal 14 and the vehicle 16 of the end time of the reservation time (steps S80 and S82).

The user terminal 14 that has received the end time of the reservation time outputs information indicating the end time to the output unit 26F of the user terminal 14. Thus, the user 22 who is using the cabin 17 of the vehicle 16 inputs the end of use of the cabin 17 by operating the user terminal 14. Upon receiving the operation instruction of the use end, the user terminal 14 transmits a use end notification to the information processing apparatus 10 (step S84).

Upon receiving the use end notification, the lending end processing module 30J of the information processing apparatus 10 performs the key information invalidation process of invalidating the key information (step S86). Then, the lending end processing module 30J of the information processing apparatus 10 transmits the use end notification of the cabin 17 to the vehicle 16 (step S88). The control unit 24A of the vehicle 16 that has received the use end notification switches the equipment of the vehicle 16 from the unlocked state to the locked state by controlling the unlocking/locking unit 24F.

The lending end processing module 30J of the information processing apparatus 10 executes the fee calculation process and calculates the fee from the time from the start of use to the end of use and the usage fee registered in the cabin management information 32D (step S90). Then, the lending end processing module 30J of the information processing apparatus 10 transmits fee information of the calculated fee to the user terminal 14 (step S92). Further, the lending end processing module 30J of the information processing apparatus 10 transmits fee information of the calculated fee and the information indicating the end of use to the lender terminal 12 (step S94).

Next, the lending end processing module 30J of the information processing apparatus 10 executes the settlement process such as direct debit of the fee of the fee information calculated in step S90 from the bank account of the user 22 and transfer to the bank account of the lender 20 (step S96).

The user terminal 14 that has received the use end notification receives operation input of the evaluation information from the user 22 (step S98). For example, the user 22 using the cabin 17 operates the user terminal 14 to input the evaluation result (evaluation information) of the cabin 17 used. In addition, the user 22 may input a use purpose of actually using the cabin 17 by operating the user terminal 14.

The user terminal 14 transmits the received evaluation information to the information processing apparatus 10 (step S100). The lending end processing module of the information processing apparatus 10 registers the evaluation information received from the user terminal 14 in the evaluation management information 32H in association with each of the vehicle ID of the corresponding vehicle 16, the cabin ID of the cabin 17, and the lender ID of the lender 20 (step S102). Therefore, the evaluation of the cabin 17 is registered in association with the ID number (identification number) of the cabin 17 of the evaluation management information 32H and the parking place (coordinates) of the vehicle 16 (step S104). Then, the lending end processing module 30J of the information processing apparatus 10 transmits information indicating registration completion of the evaluation information to the user terminal 14.

In addition, the lender 20 who has lent the cabin 17 inputs the evaluation information of the user 22 who has used the lent cabin 17 by operating the lender terminal 12. The lender terminal 12 receives operation input of the evaluation information from the lender 20 (step S106). For example, the lender 20 who has lent the cabin 17 inputs the evaluation information of the user 22 who has used the lent cabin 17 by operating the lender terminal 12. The lender terminal 12 transmits the received evaluation information to the information processing apparatus 10 (step S108). The lending end processing module 30J of the information processing apparatus 10 registers the evaluation information received from the lender terminal 12 in the evaluation management information 32H in association with the user ID of the corresponding user 22 (step S110). Then, the lending end processing module 30J of the information processing apparatus 10 transmits information indicating registration completion of the evaluation information to the lender terminal 12 (step S112).

### Second Embodiment

In a case where there is a plurality of stopping places of the vehicle 16, a method of reflecting the evaluation of each purpose of the cabin 17 when the vehicle 16 is at the first stopping place in the evaluation in the second stopping place will be described. For example, in a case where the vehicle 16 normally parked in the first stopping place is moved to the second stopping place and lent out, the evaluation received in the first stopping place is reflected in the evaluation in the second stopping place. Note that, in the second embodiment, a basic mechanism of reservation and lending of the vehicle 16 is similar to that of the first embodiment, and the description thereof will be appropriately omitted. Here, a method of reflecting the evaluation of each purpose of the cabin 17 when the vehicle 16 is at the first stopping place in the evaluation of the second stopping place will be mainly described.

First, a method of receiving evaluation of a plurality of use purposes for the cabin 17 of the same vehicle 16 at the first stopping place will be described. When actually using the cabin 17, the user 22 may have an impression different from the intended purpose of the cabin 17 that the user 22 intends to lend at the time of reservation. Since the cabin 17 can be used for various use purposes, depending on the size or equipment, the evaluation is divided such that the cabin is suitable for a conference but not suitable for breastfeeding. Thus, if the evaluation is uniformly tabulated for the preset purpose, the reliability of the evaluation that the user 22 refers to may be lost. Accordingly, after the user 22 actually uses the cabin 17, it is possible to perform evaluation for other purposes.

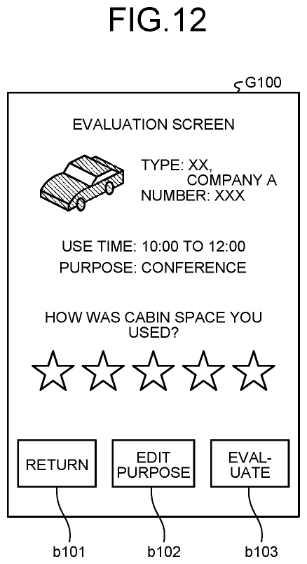

FIG. 12 is a diagram illustrating an example of an evaluation reception screen. The evaluation reception screen corresponds to an input screen for inputting evaluation. The user 22 inputs the use purpose of the cabin 17 when reserving the vehicle 16, but when evaluating the cabin 17 after using the cabin 17, the user can perform evaluation for another purpose by changing the purpose on the evaluation reception screen. This processing is processing in the evaluation reception (FIG. 11: S98), and in this processing, the evaluation reception screen G100 illustrated in FIG. 12 is transmitted from the information processing apparatus 10 to the user terminal 14, and the user 22 is caused to input the evaluation on the evaluation reception screen G100 displayed on the user terminal 14.

On an evaluation reception screen G100 illustrated in FIG. 12, vehicle information of the vehicle 16 used by the user 22 is displayed. As an example, a vehicle type and a number of the vehicle 16 are displayed.

In addition, the use time and the purpose of using the cabin 17 of the vehicle 16 are displayed. The purpose displayed here is, for example, the use purpose registered by the user 22 at the time of reservation of the cabin 17.

Various buttons (In this example, a return button b101, a purpose edit button b102, and an evaluation button b103) are provided on the evaluation reception screen G100, and the user 22 operates these buttons to evaluate various uses. Specifically, in a case where the user 22 performs evaluation while keeping the displayed purpose “meeting”, the user presses the evaluation button b103 to perform evaluation. The evaluation number is added by the number of times the user 22 presses the evaluation button b103.

When changing the purpose to be evaluated, the user 22 presses the purpose edit button b102, selects and sets the purpose that the user wants to evaluate from the purpose list, and presses the evaluation button b103 to evaluate. The evaluation result (evaluation information) input on the evaluation reception screen G100 in this manner is registered in the evaluation management information 32H (see FIG. 4) of the information processing apparatus 10 for each purpose as the evaluation of the cabin 17 at the first stopping place. Next, a method for reflecting the evaluation of the cabin 17 at the first stopping place in the evaluation of the second stopping place will be described.

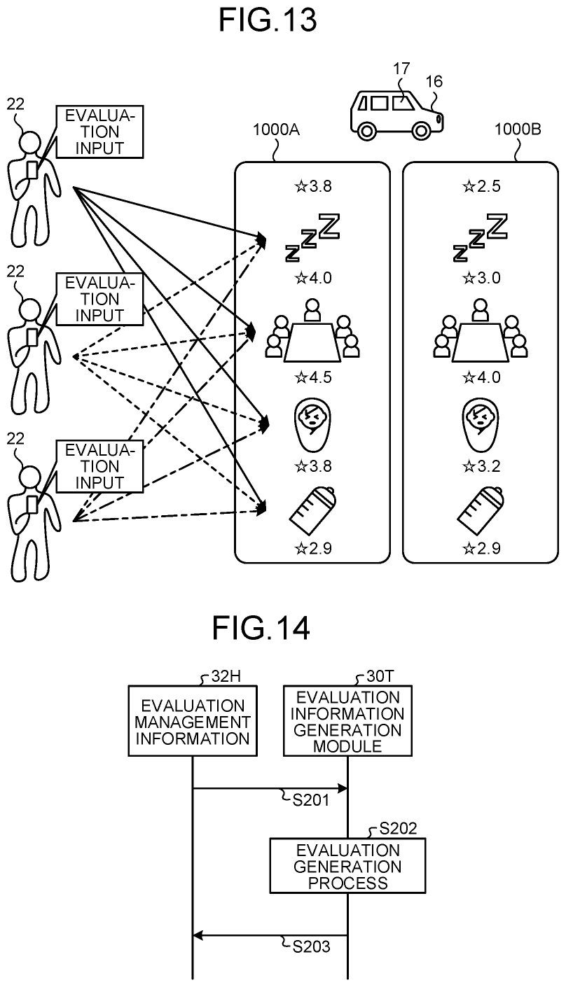

FIG. 13 is a diagram for describing a method of reflecting the evaluation at the first stopping place in the evaluation of the second stopping place. FIG. 13 illustrates an example of the evaluation of the cabin 17 at a first stopping place 1000A and the evaluation of the cabin 17 in a second stopping place 1000B. The evaluation of the cabin 17 of the first stopping place 1000A is indicated by the number of star emoji images obtained by adding the evaluation to the purpose selected by the user 22 at the time of the evaluation input in the evaluation made when the user actually uses the cabin 17 at the first stopping place. The number of star emoji images is indicated by a numerical value of one decimal place. Each icon is an icon indicating a purpose. In this example, in the first stopping place 1000A, the nap is star emoji 3.8, the meeting is star emoji 4.5, the diaper change is star emoji 3 and 8, and the breastfeeding is star emoji 2.9.

The evaluation presented at the second stopping place 1000B is an evaluation of the first stopping place 1000A generated by the evaluation information generation module 30T (see FIG. 4) using a tendency of evaluation of the other cabin 17 of the first stopping place 1000A or evaluation of the other cabin 17 of the second stopping place 1000B.

FIG. 14 is a sequence diagram illustrating an example of a process of generating an evaluation of the second stopping place 1000B. This processing is performed by the evaluation information generation module 30T. As illustrated in FIG. 14, the evaluation information generation module 30T acquires, from the evaluation management information 32H (corresponding to the evaluation management information 32H in FIG. 4), the evaluation for each purpose of the first stopping place 1000A in the cabin 17 and the evaluation for each purpose of the plurality of other cabins 17 in the second stopping place 1000B (S201).

Subsequently, the evaluation information generation module 30T performs a process (evaluation process) of generating an evaluation of the second stopping place 1000B (S202). Specifically, the evaluation information generation module 30T obtains the evaluation tendency for each purpose of the plurality of other cabins 17 of the second stopping place 1000B, applies the obtained tendency to the evaluation for each purpose of the cabin 17 of the first stopping place 1000A, and generates the evaluation for each purpose of the cabin 17 of the second stopping place 1000B. The evaluation information generation module 30T obtains, from the evaluation for each purpose of the plurality of other cabins 17, for example, a tendency that the other purpose is low for breastfeeding in the second stopping place 1000B and/or a tendency that the use of the conference increases in the second stopping place 1000B in the use ratio of the conference to the nap. The evaluation information generation module 30T sets, for example, a weight for each purpose on the basis of these, calculates a value by the weight for the evaluation for each purpose of the first stopping place 1000A, and generates the value as the evaluation for each purpose of the second stopping place 1000B.

Then, the evaluation information generation module additionally registers the generated evaluation for each purpose of the cabin 17 of the second stopping place 1000B in the evaluation management information 32H (S203).

As described above, even when the vehicle 16 is moved to the second stopping place 1000B, the evaluation information generation module 30T can generate the evaluation for each purpose of the second stopping place 1000B. Thus, the evaluation at the second stopping place 1000B can also be displayed on the screen of the user terminal 14. Therefore, when the user makes a reservation, the evaluation information of the cabin 17 at the second stopping place 1000B can be presented.

Note that, in addition to these examples, modifications can be made as appropriate. For example, when the user performs a search, the user inputs a purpose and displays only vehicles suitable for the purpose. The lender of the cabin 17 necessarily includes the permitted purpose, so that the rating is inevitably calculated for each purpose.

In the evaluation of the cabin 17, the average value of star emoji and the total number of evaluations may be simultaneously displayed. In this way, the user side can determine that the purpose with a small total number of evaluations has low credibility. In addition, the average value of star emoji and the total number of evaluations may be found for each purpose.

Although the first embodiment and the second embodiment have been described above, they can be implemented by appropriately combining them. For example, the evaluation processing described in the first embodiment and the evaluation processing described in the second embodiment may be performed together.

Note that the program for executing the processing in the above-described embodiment has a module configuration including each of the plurality of functional units, and as actual hardware, for example, a CPU (processor circuit) reads an information processing program from a ROM or an HDD and executes the information processing program, and thereby each of the plurality of functional units described above is loaded onto a RAM (main storage), and each of the plurality of functional units described above is generated on the RAM (main storage). Note that some or all of the plurality of functional units described above can also be implemented using dedicated hardware such as an application specific integrated circuit (ASIC) or a field-programmable gate array (FPGA).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

First Supplementary Note

(Supplementary Note 1)

An evaluation processing method for generating evaluation information in an information processing system that lends a cabin of a mobile body, the method comprising:
(a) registering a reservation of the cabin of the mobile body from a plurality of user terminals for a plurality of users;
(b) registering, after users of the plurality of users use the cabin of the mobile body, an evaluation for the cabin from each of user terminals for the users in registration information by the corresponding user; and
(c) acquiring, from the registration information, an evaluation result of the cabin evaluated by each of the users having used the cabin, specifying, among the users, a first user immediately before a second user who has performed an evaluation with an evaluation result different from others in chronological order, and generating evaluation information by registering an evaluation for the first user by a lender of the cabin in the registration information as the evaluation performed by the second user.

(Supplementary Note 2)

The evaluation processing method according to supplementary note 1, in which
the (c) acquiring includes acquiring, from the registration information, good evaluation information that is a good evaluation or bad evaluation information that is a bad evaluation as the evaluation result of the cabin evaluated by each of the users having used the cabin, and registering, when there is the second user who has given the bad evaluation following the first user who has given the good evaluation in chronological order in which the users have used the cabin, the evaluation of the first user by the lender of the cabin in the registration information as the bad evaluation different from the good evaluation of other users.

(Supplementary Note 3)

The evaluation processing method according to supplementary note 1 or 2, in which
the (c) acquiring includes rewriting the evaluation by the second user registered in the registration information to a same evaluation as the others, or discarding the evaluation by the second user registered in the registration information.

(Supplementary note 4)

An information processing apparatus including:
a memory; and
a processor coupled to the memory and configured to:
   receive reservation information of a cabin of a mobile body from a plurality of user terminals for a plurality of users;
   receive registration information including evaluation for the cabin from each of user terminals of the plurality of user terminals for users of the plurality of users who have used the cabin of the mobile body; and
   specify, in the registration information of the users who have used the cabin of the mobile body, among the users, a first user immediately before a second user who has performed an evaluation with an evaluation result different from others in chronological order, and register an evaluation for the first user by a lender of the cabin as the evaluation performed by the second user.

Second Supplementary Note

(Supplementary Note 1)

An evaluation processing method for generating evaluation information in an information processing system that lends a cabin of a mobile body, the method including:
(a) registering a reservation of the cabin of the mobile body from a user terminal;
(b) registering, by a user after the user uses the cabin of the mobile body, an evaluation for the cabin from the user terminal in registration information; and
(c) receiving an evaluation for a purpose different from a purpose of the user when the user inputs the evaluation for the cabin.

(Supplementary Note 2)

The evaluation processing method according to supplementary note 1, in which
the (c) receiving includes transmitting a screen for selecting a purpose of the cabin as an input screen for inputting the evaluation for the cabin to the user terminal of the user, and receiving an evaluation for the purpose selected on the input screen.

(Supplementary Note 3)

An evaluation processing method for generating evaluation information in an information processing system that lends a cabin of a mobile body, the method including:
(a) registering a reservation of the cabin of the mobile body from a plurality of user terminals for a plurality of users;
(b) selectively registering, by a user, after a user of the plurality of users uses the cabin of the mobile body, an evaluation for each of purposes of the cabin from the user terminal in registration information; and
(c) displaying, when there is a plurality of stopping places of the mobile body, by an evaluation for each of the purposes of the cabin, when the mobile body is at a first stopping place, generated based on an evaluation tendency of each of the purposes of the cabin in another mobile body at a second stopping place, an evaluation for each of the purposes of the cabin at the second stopping place.

(Supplementary Note 4)

The evaluation processing method according to supplementary note 3, in which
the (c) displaying includes displaying the evaluation for each of the purposes of the cabin at the second stopping place with a value obtained by weighting each of the purposes of the cabin, when the mobile body is at the first stopping place, based on the evaluation tendency of each of the purposes of the cabin in the other mobile body at the second stopping place.

(Supplementary Note 5)

An information processing apparatus including:
a memory; and
a processor coupled to the memory and configured to:
   receive reservation information of a cabin of a mobile body from a plurality of user terminals for a plurality of users;
   receive registration information including an evaluation for the cabin from a user terminal of a user of the plurality of users who uses the cabin of the mobile body; and
   receive an evaluation for a use purpose different from a use purpose of the cabin of the user.

(Supplementary Note 6)

An information processing apparatus including:
a memory; and
a processor coupled to the memory and configured to:
   receive reservation information of a cabin of a mobile body from a plurality of user terminals for a plurality of users;
   receive registration information including an evaluation for the cabin from a user terminal of a user of the plurality of users who uses the cabin of the mobile body; and
   register, when there is a plurality of stopping places of the mobile body, by an evaluation for each of purposes of the cabin, when the mobile body is at a first stopping place, generated based on an evaluation tendency of each of the purposes of the cabin in another mobile body at a second stopping place, an evaluation for each of the purposes of the cabin at the second stopping place.

What is claimed is:

1. An evaluation processing method for generating evaluation information in an information processing system that lends a cabin of a mobile body, the method comprising:
(a) registering a reservation of the cabin of the mobile body from a plurality of user terminals for a plurality of users;
(b) registering, after users of the plurality of users use the cabin of the mobile body, an evaluation for the cabin from each of user terminals for the users in registration information by the corresponding user; and
(c) acquiring, from the registration information, an evaluation result of the cabin evaluated by each of the users having used the cabin, specifying, among the users, a first user immediately before a second user who has performed an evaluation with an evaluation result different from others in chronological order, and generating evaluation information by registering an evaluation for the first user by a lender of the cabin in the registration information as the evaluation performed by the second user.

2. The evaluation processing method according to claim 1, wherein
the (c) acquiring includes acquiring, from the registration information, good evaluation information that is a good evaluation or bad evaluation information that is a bad evaluation as the evaluation result of the cabin evaluated by each of the users having used the cabin, and registering, when there is the second user who has given the bad evaluation following the first user who has given the good evaluation in chronological order in which the users have used the cabin, the evaluation of the first user by the lender of the cabin in the registration information as the bad evaluation different from the good evaluation of other users.

3. The evaluation processing method according to claim 1, wherein
the (c) acquiring includes rewriting the evaluation by the second user registered in the registration information to a same evaluation as the others, or discarding the evaluation by the second user registered in the registration information.

4. The evaluation processing method according to claim 2, wherein
the (c) acquiring includes rewriting the evaluation by the second user registered in the registration information to a same evaluation as the others, or discarding the evaluation by the second user registered in the registration information.

5. The evaluation processing method according to claim 1, further comprising:
(d) receiving, when a user of the cabin among the users inputs an evaluation for the cabin, an evaluation for a purpose different from a purpose of the user.

6. The evaluation processing method according to claim 2, further comprising:
(d) receiving, when a user of the cabin among the users inputs an evaluation for the cabin, an evaluation for a purpose different from a purpose of the user.

7. The evaluation processing method according to claim 3, further comprising:
(d) receiving, when a user of the cabin among the users inputs an evaluation for the cabin, an evaluation for a purpose different from a purpose of the user.

8. The evaluation processing method according to claim 5, wherein
the (d) receiving includes transmitting a screen for selecting a purpose of the cabin as an input screen for inputting an evaluation for the cabin to the user terminal of the user, and receiving an evaluation for the purpose selected on the input screen.

9. The evaluation processing method according to claim 1, further comprising:
(e) displaying, when there is a plurality of stopping places of the mobile body, by an evaluation for each of purposes of the cabin, when the mobile body is at a first stopping place, generated based on an evaluation tendency of each of the purposes of the cabin in another mobile body at a second stopping place, an evaluation for each of the purposes of the cabin at the second stopping place.

10. The evaluation processing method according to claim 9, wherein
the (e) displaying includes displaying the evaluation for each of the purposes of the cabin at the second stopping place with a value obtained by weighting each of the purposes of the cabin, when the mobile body is at the first stopping place, based on the evaluation tendency of each of the purposes of the cabin in the other mobile body at the second stopping place.

11. An information processing apparatus comprising:
a memory; and
a processor coupled to the memory and configured to:
receive reservation information of a cabin of a mobile body from a plurality of user terminals for a plurality of users;
receive registration information including evaluation for the cabin from each of user terminals of the plurality of user terminals for users of the plurality of users who have used the cabin of the mobile body; and
specify, in the registration information of the users who have used the cabin of the mobile body, among the users, a first user immediately before a second user who has performed an evaluation with an evaluation result different from others in chronological order, and register an evaluation for the first user by a lender of the cabin as the evaluation performed by the second user.

12. The evaluation processing apparatus according to claim 11, wherein
the processor is configured to acquire, from the registration information, good evaluation information that is a good evaluation or bad evaluation information that is a bad evaluation as the evaluation result of the cabin evaluated by each of the users having used the cabin, and register, when there is the second user who has given the bad evaluation following the first user who has given the good evaluation in chronological order in which the users have used the cabin, the evaluation of the first user by the lender of the cabin in the registration information as the bad evaluation different from the good evaluation of other users.

13. The evaluation processing apparatus according to claim 11, wherein
the processor is configured to rewrite the evaluation by the second user registered in the registration information to a same evaluation as the others, or discard the evaluation by the second user registered in the registration information.

14. The evaluation processing apparatus according to claim 12, wherein
the processor is configured to rewrite the evaluation by the second user registered in the registration information to a same evaluation as the others, or discard the evaluation by the second user registered in the registration information.

15. The evaluation processing apparatus according to claim 11, wherein
the processor is further configured to receive, when a user of the cabin among the users inputs an evaluation for the cabin, an evaluation for a purpose different from a purpose of the user.

16. The evaluation processing apparatus according to claim 12, wherein
the processor is further configured to receive, when a user of the cabin among the users inputs an evaluation for the cabin, an evaluation for a purpose different from a purpose of the user.

17. The evaluation processing apparatus according to claim 13, wherein
the processor is further configured to receive, when a user of the cabin among the users inputs an evaluation for the cabin, an evaluation for a purpose different from a purpose of the user.

18. The evaluation processing apparatus according to claim wherein
the processor is configured to transmit a screen for selecting a purpose of the cabin as an input screen for inputting an evaluation for the cabin to the user terminal of the user, and receive an evaluation for the purpose selected on the input screen.

19. The evaluation processing apparatus according to claim 11, wherein
the processor is further configured to display, when there is a plurality of stopping places of the mobile body, by an evaluation for each of purposes of the cabin, when the mobile body is at a first stopping place, generated based on an evaluation tendency of each of the purposes of the cabin in another mobile body at a second stopping place, an evaluation for each of the purposes of the cabin at the second stopping place.

20. The evaluation processing apparatus according to claim 19, wherein
the processor is configured to display the evaluation for each of the purposes of the cabin at the second stopping place with a value obtained by weighting each of the purposes of the cabin, when the mobile body is at the first stopping place, based on the evaluation tendency of each of the purposes of the cabin in the other mobile body at the second stopping place.
